(19) United States
(12) Patent Application Publication
(10) Pub. No.: US 2013/0143483 A1
(43) Pub. Date: Jun. 6, 2013

(54) MAINTAINING REPEATER STABILITY IN A MULTI-REPEATER SCENARIO

(71) Applicants: Dhananjay Ashok Gore, Bangalore (IN); Gwendolyn Denise Barriac, Encinitas, CA (US); Tao Tian, San Diego, CA (US); Michael Mao Wang, San Diego, CA (US); James Arthur Proctor, JR., Melbourne Beach, FL (US); Kenneth M. Gainey, San Diego, CA (US)

(72) Inventors: Dhananjay Ashok Gore, Bangalore (IN); Gwendolyn Denise Barriac, Encinitas, CA (US); Tao Tian, San Diego, CA (US); Michael Mao Wang, San Diego, CA (US); James Arthur Proctor, JR., Melbourne Beach, FL (US); Kenneth M. Gainey, San Diego, CA (US)

(73) Assignee: QUALCOMM Incorporated, San Diego, CA (US)

(21) Appl. No.: 13/312,642

(22) Filed: Dec. 6, 2011

(51) Int. Cl. H04B 7/14

(52) U.S. Cl. 455/7

(57) ABSTRACT

A wireless repeater in a multi-repeater environment operates to detect the presence of neighboring repeaters and to maintain repeater stability in the presence of a neighboring repeater. In some embodiments, the repeater transmits a known signal sequence to discover the presence of a neighboring repeater. When a neighboring repeater is detected, the repeater may apply mitigation measures to maintain operational stability at the repeater.

### BACKGROUND

1. Field

This disclosure generally relates to repeaters in wireless communication systems, and in particular, to a method for maintaining repeater stability in a multi-repeater scenario.

2. Background

Wireless communication systems and techniques have become an important part of the way we communicate. However, providing coverage can be a significant challenge to wireless service providers. One way to extend coverage is to deploy repeaters.

In general, a repeater is a device that receives a signal, amplifies the signal, and transmits the amplified signal. FIG. 1 shows a basic diagram of a repeater 110, in the context of a cellular telephone system. Repeater 110 includes a donor antenna 115 as an example network interface to network infrastructure such as a base station 125. Repeater 110 also includes a server antenna 120 (also referred to as a “coverage antenna”) as a mobile interface to mobile device 130. In operation, donor antenna 115 is in communication with base station 125, while server antenna 120 is in communication with mobile devices 130.

In repeater 110, signals from base station 125 are amplified using forward link circuitry 135, while signals from mobile device 130 are amplified using reverse link circuitry 140. Many configurations may be used for forward link circuitry 135 and reverse link circuitry 140.

There are many types of repeaters. In some repeaters, both the network and mobile interfaces are wireless; while in others, a wired network interface is used. Some repeaters receive signals with a first carrier frequency and transmit amplified signals with a second different carrier frequency, while others receive and transmit signals using the same carrier frequency. For “same frequency” repeaters, one particular challenge is managing the feedback that occurs since some of the transmitted signal can leak back to the receive circuitry and be amplified and transmitted again.

Existing repeaters manage feedback using a number of techniques; for example, the repeater is configured to provide physical isolation between the two antennae, filters are used, or other techniques may be employed.

### SUMMARY

Systems, apparatuses, and methods disclosed herein allow for enhanced repeater capability. In one embodiment, a method in a wireless repeater deployed in an environment including at least one other wireless repeater and other wireless communication devices includes transmitting a transmit signal over a first antenna of the repeater; receiving an input signal at a second antenna of the repeater, the input signal being a sum of a remote signal to be repeated, a feedback signal resulting from a feedback channel between the first antenna and the second antenna, and any interference from neighboring repeaters; processing the input signal to generate an output signal to be transmitted; generating a predetermined signal sequence to be transmitted; transmitting a transmit signal which is either the output signal, the predetermined signal sequence, or a linear combination of both; performing channel estimation using the transmitted signal or signals as well as the receive signal to generate a feedback signal estimate; and when the channel estimate is determined using the predetermined signal sequence, determining whether the feedback channel estimate has channel taps greater than a predetermined time delay as an indication of the presence of a neighboring repeater.

In some implementations, a repeater may comprise transmit circuitry configured to generate signals to transmit on a first antenna and a second antenna (a donor antenna and a server antenna), and receive circuitry to receive input signals from the first antenna and the second antenna. The transmit and receive circuitry may be implemented in hardware, software, firmware, or a combination. For example, the transmit and receive circuitry may include amplifiers, filters, demodulation/modulation circuitry, as well as processing circuitry (either as dedicated or shared processing circuitry) and may include instructions stored on memory.

The repeater may include processor circuitry to estimate a channel between the first antenna and the second antenna. For example, the processor circuitry may identify and/or determine whether there is at least one channel tap corresponding to delay greater than the delay of the feedback channel of the repeater. If so, the processing circuitry may be configured to initiate one or more mitigation measures. The processor circuitry may be implemented in hardware, software, firmware, or some combination. For example, a microprocessor, digital signal processor, application specific integrated circuit, or other hardware can be used, as can instructions stored on memory. The instructions can be implemented as software or firmware (e.g., instructions stored on EEPROPM or Electrically Erasable Programmable Read-Only Memory).

### BRIEF DESCRIPTION OF THE DRAWINGS

FIG. 1 is a simplified diagram of a repeater according to the prior art.

FIG. 2 shows a diagram of a repeater environment according to some embodiments of the present invention.

FIG. 3 illustrates a multi-repeater environment in which a neighboring repeater detection method of the present invention can be employed according to some embodiments of the present invention.

FIG. 4 illustrates the repeater operation for detecting a nearby repeater according to one embodiment of the present invention.

FIG. 5 is a flowchart illustrating the neighboring repeater detection method implemented in a repeater according to one embodiment of the present invention.

FIG. 6 is a block diagram of a repeater implementing the neighboring repeater detection method according to one embodiment of the present invention.

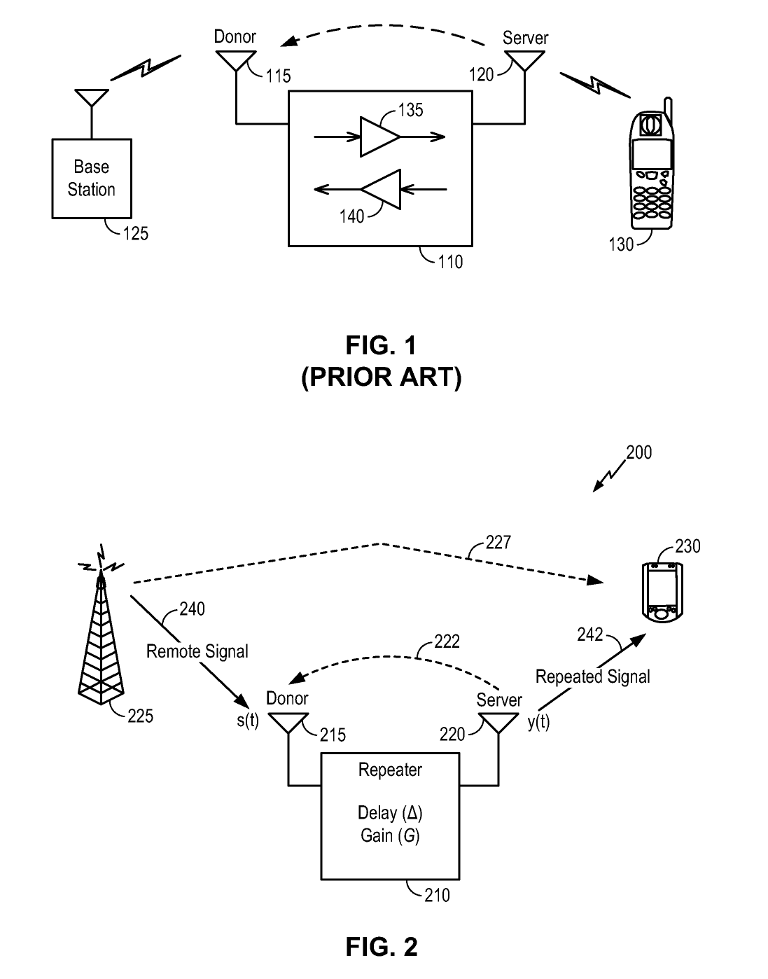

### DETAILED DESCRIPTION

The nature, objectives, and advantages of the disclosed method and apparatus will become more apparent to those skilled in the art after considering the following detailed description in connection with the accompanying drawings.

Prior art repeaters such as those described above may provide significant advantages for cellular telephone or similar networks. However, existing repeater configurations may not be suitable for some applications. For example, existing repeater configurations may not be suitable for indoor coverage applications (e.g., repeating signals for a residence or business environment) which may require substantially more isolation between the repeater's antennas. Moreover, in some traditional repeater implementations, the target is to achieve as high a gain as reasonable while maintaining a stable feedback loop (loop gain less than unity). However, increasing the repeater gain renders isolation more difficult due to the increased signal leaking back into the donor antenna. In general, loop stability demands require that the signal leaking back into the donor antenna from the coverage antenna be much lower than the remote signal (the signal to be repeated). The maximum achievable signal to interference/noise ratio (SINR) at the output of the repeater is then the same as the SINR at the input to the repeater. High gain and improved isolation form two contradicting demands required for modern day repeaters, especially those for indoor applications.

FIG. 2 shows a diagram of an operating environment 200 for a repeater 210 according to embodiments of the present invention. In FIG. 2, a remote signal 240 from a base station 225 is intended for a mobile device 230. A repeater, such as repeater 210, may be used in operating environment 200 if an un-repeated signal along the path 227 between base station 225 and mobile device 230 would not provide sufficient signal for effective voice and/or data communications received at mobile device 230. Repeater 210 with a gain G and a delay Δ is configured to repeat a signal received from base station 225 on a donor antenna 215 (“the receiving antenna” for the forward link) and amplify and transmit the repeated signal 242 to mobile device 230 using a server antenna 220 (“the transmitting antenna” for the forward link) Repeater 210 includes forward link circuitry for amplifying and transmitting signals received from the base station 225 to mobile device 230 through donor antenna 215 and server antenna 220. Repeater 210 may also include reverse link circuitry for amplifying and transmitting signals from mobile device 230 back to base station 225. At repeater 210, the remote signal s(t) is received as an input signal and the remote signal s(t) is repeated as a repeated or amplified signal y(t) where y(t)=\sqrt{G}s(t−Δ). Ideally, the gain G would be large, the inherent delay Δ of the repeater would be small, the input SINR would be maintained at the output of repeater 210 (this can be of particular importance for data traffic support), and only desired carriers would be amplified.

In practice, the gain of repeater 210 is limited by the isolation between donor antenna 215 and server antenna 220. If the gain is too large, the repeater can become unstable due to signal leakage. Signal leakage refers to the phenomenon where a portion of the signal that is transmitted from one antenna (in FIG. 2, server antenna 220) is received by the other antenna (in FIG. 2, donor antenna 215), as shown by the feedback path 222 in FIG. 2. Without interference cancellation or other techniques, the repeater would amplify this feedback signal, also referred to as the leakage signal, as part of its normal operation, and the amplified feedback signal would again be transmitted by server antenna 220. The repeated transmission of the amplified feedback signal due to signal leakage and high repeater gain can lead to repeater instability. Additionally, signal processing in repeater 210 has an inherent non-negligible delay Δ. The output SINR of the repeater is dependent on RF non-linearities and other signal processing. Thus, the aforementioned ideal repeater operational characteristics are often not attained. Finally, in practice, the desired carriers can vary depending on the operating environment or market in which the repeater is deployed. It is not always possible to provide a repeater that amplifies only the desired carriers.

In a same-frequency repeater, the incoming signal is retransmitted on the same frequency as which it is received. In cases where high gain is desired than there is isolation in the antennas, interference cancellation is often used to increase the stability of the repeater and increase the overall gain.

In embodiments of the present disclosure, a wireless repeater employs interference cancellation or echo cancellation to improve the isolation between the repeaters' donor antenna (“the receiving antenna” for forward link communications) and the coverage antenna (“the transmitting antenna” for forward link communications). Interference cancellation is accomplished by actively cancelling out the transmit signal received on the repeater's own receive signal, referred to as the “leakage signal” or the “feedback signal.” In some cases, interference cancellation is carried out in baseband that is in the digital domain. Baseband interference cancellation is accomplished by storing a digital reference of the signal to be transmitted and using this digital reference to estimate the feedback channel. The feedback channel estimate is then used to estimate the feedback signal so as to actively cancel the leakage signal.

More specifically, the echo cancellation process involves estimating the feedback channel using the transmit signal as a reference signal, convolving the feedback channel estimate with the transmit signal to generate a feedback signal estimate, and applying the feedback signal estimate to cancel the undesired feedback signal in the receive signal. Effective echo cancellation requires very accurate channel estimation of the leakage channel. In general, the more accurate the channel estimate, the higher the cancellation and hence the higher the effective isolation. Herein, “interference cancellation” or “echo cancellation” refers to techniques that cancel an estimated feedback signal to reduce or eliminate the amount of leakage signal between repeater antennas; that is, “interference cancellation” refers to partial or complete cancellation of the leakage signal.

### Multiple Repeater Environment

A repeater is often installed in an environment where one or more other repeaters are present. Stability and interference of the repeater's operation in the presence of multiple RF repeaters are common concerns. A typical repeater receives a remote signal, amplifies the remote signal and then transmits the amplified remote signal as the output signal. Part of the transmitted signal leaks back into the receiver over a feedback channel. If the isolation between the donor and coverage antennas is large enough, the system remains stable. However, if there are other repeaters in the coverage zone, the transmitted signal from the output of one repeater will be received by another and vice versa. Signal leakage in a multiple repeater environment can cause problems in maintaining stability of the individual repeater. A repeater operating in a multi-repeater environment can lead to poor repeater performance. Such a scenario can arise in unplanned repeater deployments; for example, when one person unknowingly installs repeaters near currently operating repeaters.

### Neighboring Repeater Detection

According to one aspect of the present invention, systems and techniques herein provide for improving repeater performance in a multi-repeater environment. In embodiments of the present invention, a repeater in a multi-repeater environment operates to detect the presence of neighboring repeaters and to maintain repeater stability in the presence of a neighboring repeater. In some embodiments, the repeater transmits a known signal sequence to discover the presence of a neighboring repeater. When a neighboring repeater is detected, the repeater may apply mitigation measures to maintain operational stability at the repeater.

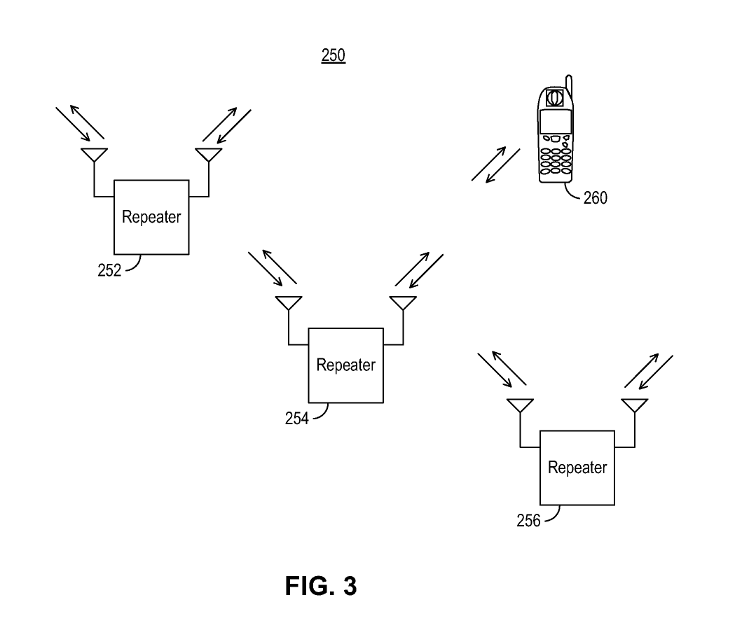

FIG. 3 illustrates a multi-repeater environment in which a neighboring repeater detection method of the present invention can be employed according to some embodiments of the present invention. Referring to FIG. 3, in a multi-repeater environment 250, two or more repeaters 252, 254 and 256 may be operating with overlapping coverage area. Each of repeaters 252, 254 and 256 transmits downlink communications and receives uplink communications. A wireless communication device 260 may be communicating with a base station through one of the repeaters in multi-repeater environment 250. In the present description, the wireless communication device 260 may be a cellular handset or a mobile telephone, a personal communication system device, a personal information manager, a personal digital assistant, a laptop computer or other mobile or stationary devices which are capable of receiving and transmitting wireless communication.

According to one embodiment of the present invention, one or more of repeaters 252, 254 and 256 implement a neighboring repeater detection method of the present invention to discover the presence of other repeaters in the repeater's own coverage area. When a neighboring repeater is detected, the repeater may implement one or more mitigation strategies to mitigate interference or other degradation due to the presences of multiple repeaters in the same coverage area.

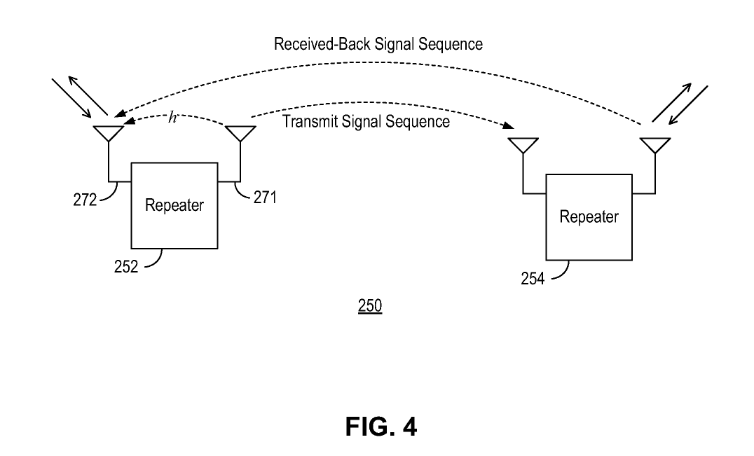

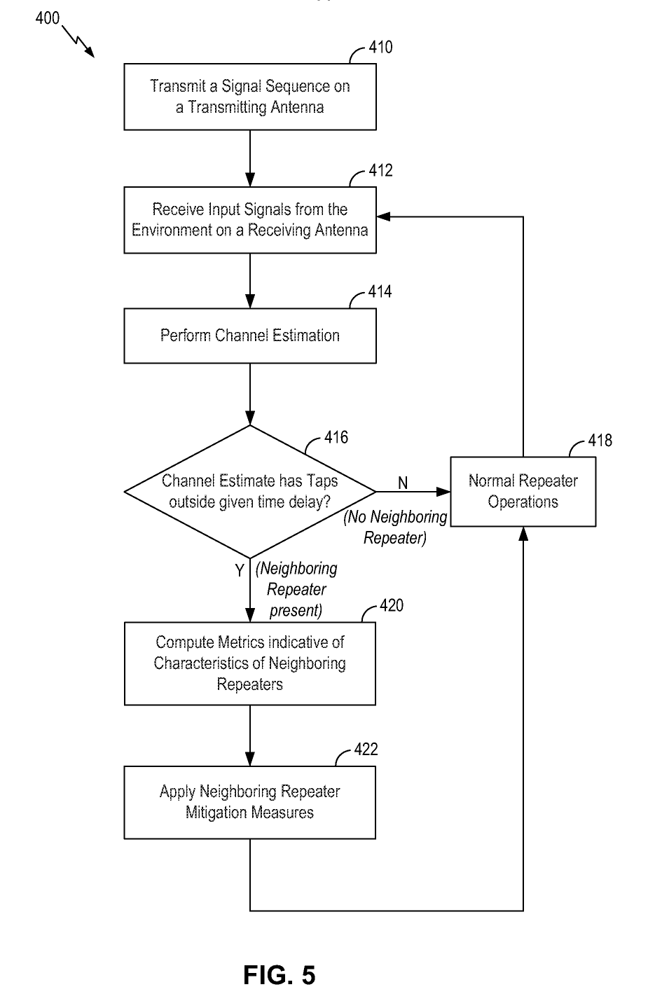

The neighboring repeater detection method of the present invention will be described with reference to FIG. 4 and FIG. 5. FIG. 4 illustrates the repeater operation for detecting a nearby repeater according to one embodiment of the present invention. FIG. 5 is a flowchart illustrating the neighboring repeater detection method implemented in a repeater according to one embodiment of the present invention. Referring to FIGS. 4 and 5, a repeater 252, implementing the neighboring repeater detection method 400 of the present invention, transmits a known signal sequence (the “transmit signal sequence”) on a first antenna 271 (step 410). The repeater 252 may transmit the known signal sequence periodically to detect the presence of neighboring repeaters. In one embodiment, the known signal sequence is a random noise signal transmitted in the same frequency as the intended transmit signal.

The repeater 252 then determines if the transmit signal sequence is received back on its second antenna after a given delay excluding the delay of its own feedback channel. More specifically, the repeater 252 receives input signals on a second antenna 272 (step 412). The input signal received on the second antenna 272 may be a feedback signal resulted from a feedback channel h between the first antenna 271 and the second antenna 272. A feedback signal received on the second antenna 272 will have a first delay from the transmit signal being transmitted from the first antenna 271 indicative of the delay of the feedback channel h. Accordingly, when the repeater 252 transmits the transmit signal sequence on the first antenna 271, the same signal sequence will be received by the second antenna 272 as a feedback signal after the delay of the feedback channel. However, the same transmit signal sequence may be received and transmitted by a neighboring repeater 254. In that case, the repeater 252 may receive on the second antenna 272 an input signal that is the transmit signal sequence being transmitted by the neighboring repeater 254 and referred to as the “received-back signal sequence”. The received-back signal sequence originated from the neighboring repeater 254 will have a different delay, typically longer, then the delay of the repeater 252's own feedback channel h.

Accordingly, method 400 proceeds with performing channel estimation based on the input signals (step 414). Because the feedback signal of the repeater and the received-back signal sequence contains the same transmit signal sequence, the repeater treats the received-back signal sequence as if it is a feedback signal but with a different channel tap, that is, a different time delay. The channel estimation process identifies the channel taps or the delay spread of each input signal. The repeater determines if an input signal has channel taps outside a given time range (step 416). If an input signal has channel taps outside a given time delay, then the repeater recognizes such longer channel taps as indicator of a neighboring repeater. That is, when the repeater 252 receives the same transmit signal sequence back on its second antenna 272 with a delay that is longer than the delay of its own feedback channel h, then the repeater 252 can conclude that there is a repeater 254 present in the neighborhood or within the same coverage area.

When the repeater 252 determines that there is a neighboring repeater, the repeater may then proceed with taking mitigation measures to maintain the stability of the repeater. On the other hand, if the repeater 252 determines that there is no neighboring repeater, that is, there is no channel tap outside of the given time delay, the repeater 252 may continue with normal repeater operations (step 418). Method 400 repeats at step 410 where the transmit signal sequence is periodically transmitted.

### Mitigation Measures

According to embodiments of the present invention, the repeater may undertake one or more mitigation measures once a neighboring repeater is detected using method 400 above. For instance, from the received-back signal sequence, the repeater 252 can determine information about the neighboring repeater, such as how far away it is, how much power it is transmitting, and other characteristics of the neighboring repeater. Accordingly, the repeater 252 may initiate mitigation measures to reduce inter-repeater interference and maintain stability of operation even in the presence of the neighboring repeater 254.

In one embodiment, after detecting channel taps outside of the given time delay to indicate the presence of a neighboring repeater, method 400 continues with computing a metric indicative of characteristics of the neighboring repeater (step 420). In one embodiment, the method computes a metric indicative of the received power from the neighboring repeater 254. Method 400 may then apply mitigation measures (step 422) to maintain stability of operation in the presence of neighboring repeaters. In one embodiment, the repeater 252 may reduce its gain to an acceptable level. In another embodiment, after adjusting the gain, the repeater 252 may change a controllable internal delay amount to mitigate interference from the neighboring repeater. That is, the repeater 252 may change its delay such that its channel estimate is not adversely affected by the other repeater. Finally, in yet another embodiment, the repeater may change its operation mode, such as to an insert pilot mode to allow the repeater to operate in the presence of other repeaters but with reduced SNR. In the present description, the “insert pilot mode” refers to a repeater which inserts a pilot signal to the transmit signal and uses the received-back pilot signal for channel estimation.

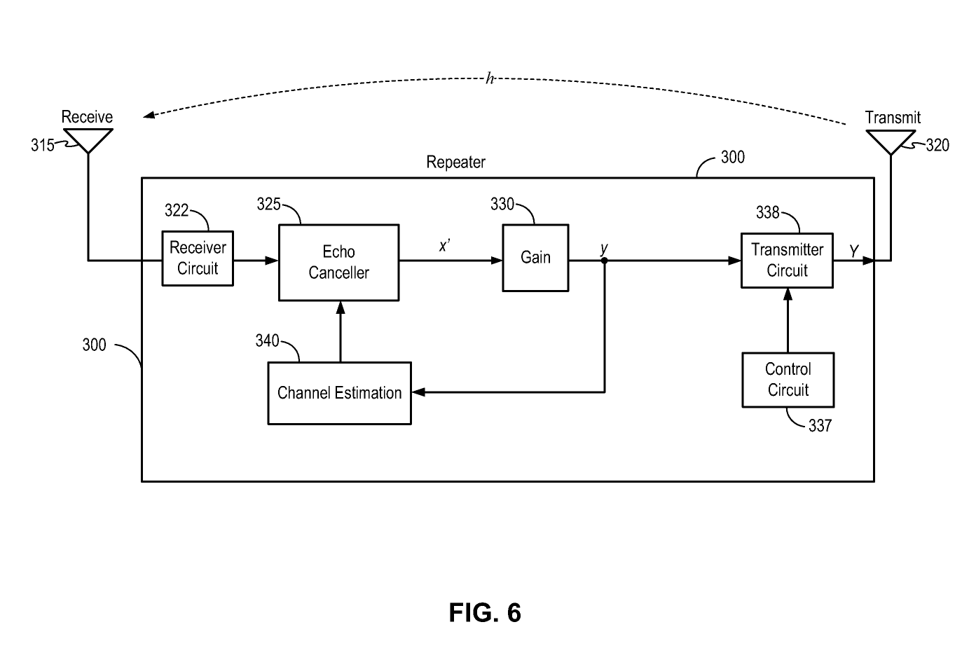

FIG. 6 is a block diagram of a repeater implementing the neighboring repeater detection method according to one embodiment of the present invention. Referring to FIG. 6, an interference cancellation repeater 300 receives a remote signal X on a receiving antenna 315 (which may be the donor antenna or the server antenna) to be repeated and generates an output signal Y to be transmitted on a transmitting antenna 320 (which is the other of the donor antenna or the server antenna). The repeater 300 includes a receiver circuit 322 and a transmitter circuit 338 incorporating digital and analog front-end processing circuitry for implementing the receive and transmit functions of the repeater. Receiver circuit 322 and transmitter circuit 338 are generally connected to both antennas of the repeater, but are shown here connected to only one antenna for simplicity. In general, the receiver and transmitter circuits include variable gain amplifiers, power amplifiers, filters, mixers, drivers, analog-to-digital converters and digital-to-digital converters. The specific implementation of the receiver circuit 322 and the transmitter circuit 338 is not critical to the practice of the present invention and any receiver/transmitter front-end processing circuitry, presently known or to be developed, can be applied in the wireless repeater of the present invention.

In operation, signal leakage from the transmitting antenna 320 back to the receiving antenna 315 of the repeater 300 causes part of the output signal Y to be leaked back through a feedback channel h and added to the remote signal X before the signal is received by the repeater. Thus, the repeater 300 actually receives a composite receive signal being the sum of the remote signal X, the feedback signal where the feedback signal is basically an attenuated version of the output signal Y, and any additional interference from other repeaters. The repeater 300 includes an echo canceller 325 for performing echo cancellation to remove all or part of the feedback signal. The echo cancelled signal x′ is provided to a variable gain stage 330 to be amplified. The amplified signal is the transmit signal y which is provided to the transmitter circuit 338 to generate the repeater output signal Y to be transmitted on the transmitting antenna 320. A channel estimation block 340 receives the transmit signal y as a reference signal and performs channel estimation to generate a feedback channel estimate. The feedback channel estimate in turn is used to generate a feedback signal estimate for use by the echo canceller 325 to cancel the undesired feedback signal in the receive signal. Repeater 300 may include other functional blocks not shown in FIG. 6, such as a gain control block.

In FIG. 6, only the forward link circuitry of repeater 300 for amplifying signals received on the receiving antenna 315 and transmitting signals on a transmitting antenna 320 is shown. Repeater 300 may also include reverse link circuitry for amplifying and transmitting signals from the transmitting antenna 320 to the receiving antenna 315.

In the present embodiment, repeater 300 includes a control circuit 337 to supply a supplemental signal sequence for transmission on the transmitting antenna 320 (either with or without a repeated signal). More specifically, the signal sequence is provided to the transmitter circuit 338 to be processed into the repeater output signal Y. The signal sequence may be transmitted periodically to enable detection of neighboring repeaters.

Many implementations for repeater 300 can be used to carry out the techniques disclosed herein. For example, each of receiver circuit 322, echo canceller 325, channel estimation block 340, variable gain stage 330, transmitter circuit 338 and control circuit 337 can be implemented in hardware, software, and/or firmware. Additionally, some of the circuitry shown as functional modules can be shared and/or included in modules different than those shown in FIG. 6. For example, repeater 300 may include processor circuitry that can access memory to perform channel estimation and control (e.g., processor circuitry can perform some functions from different modules of FIG. 6, and can also provide other repeater functions not discussed here). For example, according to techniques herein, processor circuitry can estimate a channel between the donor antenna and the server antenna, and identify channel taps corresponding to different delays. If the processor circuitry can identify any channel taps that do not correspond to the delay of the feedback channel of the repeater, that can be an indication that the signal responsible for that channel tap originated with a different repeater. As a result, the processor circuitry can be configured to initiate one or more mitigation measures based on identifying at least one channel tap different than the feedback channel for the repeater

The communication system in which the repeater of the present invention can be deployed includes various wireless communication networks based on infrared, radio, and/or microwave technology. Such networks can include, for example, a wireless wide area network (WWAN), a wireless local area network (WLAN), a wireless personal area network (WPAN), and so on. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as CDMA2000, Wideband-CDMA (W-CDMA), and so on. CDMA2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). CDMA2000 is described in documents from a consortium named “3rd Generation Partnership Project 2” (3GPP2). 3GPP and 3GPP2 documents are publicly available. The current techniques may be implemented using 4G systems such as Long Term Evolution (LTE), as well as future technologies and protocols. A WLAN may be an IEEE 802.11x network, and a WPAN may be a Bluetooth network, an IEEE 802.15x, or some other type of network. The systems and techniques described herein may also be used for any combination of WWAN, WLAN and/or WPAN.

Those skilled in the art will understand that information and signals may be represented using any of a variety of different technologies and techniques. For example: data, information, signals, bits, symbols, chips, instructions, and commands may be referenced throughout the above description. These may be represented by voltages, currents, electromagnetic waves, magnetic fields or particles, optical fields or particles, or any combination thereof.

In one or more of the above-described embodiments, the functions and processes described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The term “control logic” used herein applies to software (in which functionality is implemented by instructions stored on a machine-readable medium to be executed using a processor), hardware (in which functionality is implemented using circuitry (such as logic gates), where the circuitry is configured to provide particular output for particular input, and firmware (in which functionality is implemented using re-programmable circuitry), and also applies to combinations of one or more of software, hardware, and firmware.

For a firmware and/or software implementation, the methodologies may be implemented with modules (e.g., procedures, functions, and so on) that perform the functions described herein. Any machine readable medium tangibly embodying instructions may be used in implementing the methodologies described herein. For example, software codes may be stored in a memory, for example the memory of mobile station or a repeater, and executed by a processor, for example the microprocessor of modem. Memory may be implemented within the processor or external to the processor. As used herein the term “memory” refers to any type of long term, short term, volatile, nonvolatile, or other memory and is not to be limited to any particular type of memory or number of memories, or type of media upon which memory is stored. The phrases “computer readable medium,” “storage medium,” and the like are used herein to refer to manufactures and not to refer to transitory propagating signals.

Moreover, the previous description of the disclosed implementations is provided to enable any person skilled in the art to make or use the present invention. Various modifications to these implementations will be readily apparent to those skilled in the art, and the generic principles defined herein may be applied to other implementations without departing from the spirit or scope of the invention. Thus, the present invention is not intended to be limited to the features shown herein but is to be accorded the widest scope consistent with the principles and novel features disclosed herein.

What is claimed is:

1. A method in a wireless repeater deployed in an environment including at least one other wireless repeater and other wireless communication devices, the method comprising:
transmitting a transmit signal over a first antenna of the wireless repeater;
receiving an input signal at a second antenna of the wireless repeater, the input signal being a sum of a remote signal to be repeated, a feedback signal resulting from a feedback channel between the first antenna and the second antenna, and any interference from neighboring repeaters;
processing the input signal to generate an output signal to be transmitted;
generating a predetermined signal sequence to be transmitted;
transmitting a transmit signal which is either the output signal, the predetermined signal sequence, or a combination of both;
performing channel estimation using the transmit signal or signals as well as a receive signal to generate a feedback signal estimate; and
when the channel estimate is determined using the predetermined signal sequence, determining whether the feedback channel estimate has one or more channel taps corresponding to a delay greater than a predetermined time delay as an indication of presence of a neighboring repeater.

2. The method of claim 1, wherein when the feedback channel estimate has one or more channel taps corresponding to the delay greater than the predetermined time delay, the method further comprises:
initiating a mitigation measure to reduce inter-repeater interference.

3. The method of claim 2, wherein initiating the mitigation measure to reduce inter-repeater interference comprises:
reducing a gain of the wireless repeater.

4. The method of claim 2, wherein initiating the mitigation measure to reduce inter-repeater interference comprises:
changing a controllable internal delay amount of the wireless repeater so as to mitigate effects of interference from the neighboring repeater.

5. The method of claim 2, wherein initiating the mitigation measure to reduce inter-repeater interference comprises:
changing an operation mode of the wireless repeater to support operation in multi-repeater environment.

6. The method of claim 5, wherein changing the operation mode of the wireless repeater to support operation in multi-repeater environment comprises:
operating the wireless repeater using an inserted pilot signal where the output signal includes an inserted pilot to be used in channel estimation.

7. The method of claim 1, wherein processing the input signal to generate the output signal comprises:
cancelling a feedback signal estimate from the input signal to generate an echo cancelled signal; and
amplifying the echo cancelled signal as the output signal to be transmitted.

8. The method of claim 1, wherein transmitting the predetermined signal sequence over the first antenna of the wireless repeater comprises transmitting the predetermined signal sequence over the first antenna periodically.

9. A computer readable medium having stored thereon computer executable instructions for performing at least the following acts:
transmitting a transmit signal over a first antenna of a repeater;
receiving an input signal at a second antenna of the repeater, the input signal being a sum of a remote signal to be repeated, a feedback signal resulting from a feedback channel between the first antenna and the second antenna, and any interference from neighboring repeaters;
processing the input signal to generate an output signal to be transmitted, generating a predetermined signal sequence to be transmitted;
transmitting a transmit signal which is either the output signal, the predetermined signal sequence, or a linear combination of both;
performing channel estimation using the transmit signal or signals as well as a receive signal to generate a feedback signal estimate; and
when the channel estimate is determined using the predetermined signal sequence, determining whether the channel estimate has channel taps greater than a predetermined time delay as an indication of presence of a neighboring repeater.

10. The computer readable medium of claim 9 having stored thereon further computer executable instructions for performing at least the following acts:
initiating a mitigation measure to reduce inter-repeater interference, when the feedback channel estimate has channel taps greater than the predetermined time delay.

11. The computer readable medium of claim 10 having stored thereon further computer executable instructions for performing at least the following acts:
reducing a gain of the repeater as the mitigation measure to reduce inter-repeater interference.

12. The computer readable medium of claim 10 having stored thereon further computer executable instructions for performing at least the following acts:
changing controllable internal delay amount of the repeater so as to mitigate effects of interference from the neighboring repeater.

13. The computer readable medium of claim 10 having stored thereon further computer executable instructions for performing at least the following acts:
changing an operation mode of the repeater to support operation in multi-repeater environment as the mitigation measure to reduce inter-repeater interference.

14. A repeater comprising:
transmit circuitry configured to generate signals to transmit on a first antenna and a second antenna;
receive circuitry to receive input signals from the first antenna and the second antenna, the input signals including a first input signal;
processor circuitry to:
estimate a channel between the first antenna and the second antenna, wherein estimating the channel between the first antenna and the second antenna comprises identifying at least one channel tap corresponding to a feedback channel of the repeater;
determine whether the first input signal includes at least one channel tap different than the at least one channel tap corresponding to the feedback channel of the repeater; and
if the first input signal includes at least one channel tap different than the at least one channel tap corresponding to the feedback channel of the repeater, initiate one or more mitigation measures.

15. The repeater of claim 14, further including the first antenna and the second antenna, wherein the first antenna is in communication with the receive circuitry and the transmit circuitry, and the second antenna is in communication with the receive circuitry and the transmit circuitry.

16. The repeater of claim 14, wherein the processor circuitry is further configured to generate a supplemental signal sequence.

17. The repeater of claim 16, wherein estimating the channel between the first antenna and the second antenna comprises estimating the channel using the supplemental signal sequence.

18. The repeater of claim 16, wherein the repeater is configured to:
process and amplify the first input signal to generate a first output signal; and
add the supplemental signal sequence to a first transmit signal.

19. The repeater of claim 14, wherein the at least one channel tap different than the feedback channel of the repeater corresponds to a delay greater than a delay associated with processing and transmitting the first input signal at the repeater.

20. The repeater of claim 14, wherein initiating the one or more mitigation measures comprises initiating a gain reduction process.

21. The repeater of claim 14, wherein initiating the one or more mitigation measures comprises modifying a controllable internal delay amount.

22. A repeater comprising:
means for generating signals to transmit on a first antenna and a second antenna;
means for receiving input signals from the first antenna and the second antenna, the input signals including a first input signal;
means for estimating a channel between the first antenna and the second antenna, wherein the means for estimating the channel between the first antenna and the second antenna comprises means for identifying at least one channel tap corresponding to a feedback channel of the repeater;
means for determining whether the first input signal includes at least one channel tap different than the at least one channel tap corresponding to the feedback channel of the repeater; and
means for initiating one or more mitigation measures if the first input signal includes at least one channel tap different than the at least one channel tap corresponding to the feedback channel of the repeater.

23. The repeater of claim 22, further including the first antenna and the second antenna, wherein the first antenna is in communication with the means for receiving and a means for transmitting, and the second antenna is in communication with the means for receiving and the means for transmitting.

24. The repeater of claim 22, further comprising means for generating a supplemental signal sequence.

25. The repeater of claim 24, wherein the means for estimating the channel between the first antenna and the second antenna comprises means for estimating the channel using the supplemental signal sequence.

26. The repeater of claim 24, wherein the repeater further comprises:
means for processing and amplifying the first input signal to generate a first transmit signal; and
means for adding the supplemental signal sequence to the first transmit signal.

27. The repeater of claim 22, wherein the at least one channel tap different than the feedback channel of the repeater corresponds to a delay greater than a delay associated with processing and transmitting the first input signal at the repeater.

28. The repeater of claim 22, wherein the means for initiating the one or more mitigation measures comprises means for initiating a gain reduction process.

29. The repeater of claim 22, wherein means for initiating the one or more mitigation measures comprises means for modifying a controllable internal delay amount.
